(19) United States
(12) Patent Application Publication
(10) Pub. No.: US 2026/0274579 A1
(43) Pub. Date: Sep. 17, 2026

(54) TELESCOPIC CONVEYOR

(71) Applicant: FMH Conveyors LLC, Jonesboro, AR (US)

(72) Inventors: Jeffrey Lynn Fielder, Jonesboro, AR (US); Mark David Haustein, Jonesboro, AR (US)

(21) Appl. No.: 19/563,272

(22) Filed: Mar. 11, 2026

Related U.S. Application Data
(60) Provisional application No. 63/772,069, filed on Mar. 14, 2025.

(51) Int. Cl. B65G 21/14; B65G 41/00

(52) U.S. Cl. CPC B65G 21/14; B65G 41/008

(57) ABSTRACT

A telescopic conveyor including: a base section in which each of a first side frame member and a second side frame member includes a first cam roller support assembly coupled to the base frame and including a first cam roller assembly and a second cam roller assembly; and an extensible section movable relative to the base section and including a first side frame member and a second side frame member opposite the first side frame member; wherein as the extensible section moves relative to the base section between a retracted position and an extended position, the first cam roller assembly of the first cam roller support assembly engages a lower flange of the first side frame member of the extensible section and the second cam roller assembly of the first cam roller support assembly engages a lower flange of the second side frame member of the extensible section.

### CROSS-REFERENCE TO RELATED APPLICATIONS

The present application claims priority to U.S. Provisional Patent Application No. 63/772,069, filed Mar. 14, 2025, the entire contents of which are incorporated herein by reference.

### FIELD OF THE INVENTION

The present invention relates to powered telescopic conveyors.

### SUMMARY OF THE INVENTION

In some aspects, the techniques described herein relate to a telescopic conveyor including: a base section including a base frame including a first side frame member and a second side frame member opposite the first side frame member, each of the first and second side frame members including an upper flange; a lower flange; and a first cam roller support assembly coupled to the base frame and including a first cam roller assembly and a second cam roller assembly; and an extensible section supported by and movable relative to the base section, the extensible section configured to move relative to the base section between a retracted position and an extended position; an extensible frame including a first side frame member and a second side frame member opposite the first side frame member, each of the first and second side frame members including an upper flange; and a lower flange; wherein as the extensible section moves between the retracted position and the extended position, the first cam roller assembly of the first cam roller support assembly engages the lower flange of the first side frame member of the extensible section and the second cam roller assembly of the first cam roller support assembly engages the lower flange of the second side frame member of the extensible section.

In some aspects, the techniques described herein relate to a telescopic conveyor, wherein the extensible frame further includes a second cam roller support assembly coupled to the extensible frame and configured to engage the base frame.

In some aspects, the techniques described herein relate to a telescopic conveyor, wherein as the extensible section moves between the retracted position and the extended position, the first cam roller assembly of the second cam roller support assembly engages the upper flange of the first side frame member of the base section and the second cam roller assembly of the second cam roller support assembly engages the upper flange of the second side frame member of the base section.

In some aspects, the techniques described herein relate to a telescopic conveyor, wherein the first cam roller support assembly is positioned adjacent a rear of the base frame and the second cam roller support assembly is positioned adjacent a front of the extensible frame.

In some aspects, the techniques described herein relate to a telescopic conveyor including: a base section including a base frame including a first side frame member and a second side frame member opposite the first side frame member, each of the first side frame member and the second side frame member supporting a base conveyor belt and including an upper flange; a lower flange; and a first cam roller support assembly coupled to the base frame and including a first cam roller assembly and a second cam roller assembly; and an extensible section supported by and movable relative to the base section, the extensible section configured to move relative to the base section between a retracted position and an extended position, the extensible section including an extensible frame including a first side frame member and a second side frame member opposite the first side frame member, each of the first side frame member and the second side frame member supporting an extensible conveyor belt and including an upper flange; and a lower flange; wherein as the extensible section moves between the retracted position and the extended position, the first cam roller assembly of the first cam roller support assembly engages the lower flange of the first side frame member of the extensible section and the second cam roller assembly of the first cam roller support assembly engages the lower flange of the second side frame member of the extensible section.

In some aspects, the techniques described herein relate to a telescopic conveyor including: a plurality of sections including a base section; and a plurality of extensible sections supported by and movable relative to the base section; wherein each of the plurality of sections includes a frame supporting a conveyor belt and including a first side frame member and a second side frame member opposite the first side frame member, each of the first side frame member and the second side frame member including an upper flange and a lower flange; and a plurality of roller support assemblies, each roller support assembly of the plurality of roller support assemblies being supported by the frame of one of the plurality of sections and positioned between the one of the plurality of sections and an adjacent section of the plurality of sections, each of the plurality of roller support assemblies including a first cam roller support assembly coupled to the frame of the one of the plurality of sections and including a first cam roller assembly and a second cam roller assembly; wherein the first cam roller assembly of the first cam roller support assembly engages one of the upper flange and the lower flange of the first side frame member of the adjacent section of the plurality of sections and the second cam roller assembly of the first cam roller support assembly engages one of the upper flange and the lower flange of the second side frame member of the adjacent section of the plurality of sections.

In some aspects, the techniques described herein relate to a telescopic conveyor including: a base section including a base frame including a first side frame member and a second side frame member opposite the first side frame member, each of the first side frame member and the second side frame member supporting a base conveyor belt and including an upper flange; a lower flange; and an extensible section supported by and movable relative to the base section, the extensible section configured to move relative to the base section between a retracted position and an extended position, the extensible section including an extensible frame including a first side frame member and a second side frame member opposite the first side frame member, each of the first side frame member and the second side frame member supporting an extensible conveyor belt and including an upper flange; a lower flange; and a first cam roller support assembly coupled to the extensible frame and including a first cam roller assembly and a second cam roller assembly; wherein as the extensible section moves between the retracted position and the extended position, the first cam roller assembly of the first cam roller support assembly engages the upper flange of the first side frame member of the base section and the second cam roller assembly of the first cam roller support assembly engages the upper flange of the second side frame member of the base section.

In some aspects, the techniques described herein relate to a cam roller support assembly configured to be positioned between a first section of a telescopic conveyor and a second section of a telescopic conveyor that is movable between a retracted position and an extended position relative to the first section, the cam roller support assembly including: a first plate including a first cam roller assembly having a first cam roller rotatable about a first axis and a second cam roller rotatable about a second axis that is parallel to the first axis; a second plate including a second cam roller assembly having a first cam roller rotatable about the first axis and a second cam roller rotatable about the second axis; and a support plate coupled to and extending between the first plate and the second plate, the support plate positioned between and parallel to the first axis and the second axis.

In some aspects, the techniques described herein relate to a cam roller support assembly, wherein the first cam roller assembly includes a third cam roller rotatable about a third axis that is parallel to both the first axis and the second axis, the third axis being on the same side of the support plate as the second axis, and wherein the second cam roller assembly includes a third cam roller rotatable about the third axis.

In some aspects, the techniques described herein relate to a cam roller support assembly, wherein the first axis is positioned between the second axis and the third axis.

In some aspects, the techniques described herein relate to a cam roller support assembly, wherein the first cam roller of each of the first cam roller assembly and the second cam roller assembly is at least partially positioned within a notch in the support plate such that the first cam roller and the second cam roller of each of the first cam roller assembly and the second cam roller assembly are configured to engage upper and lower surfaces of a flange of one of the first section and the second section.

In some aspects, the techniques described herein relate to a cam roller support assembly, further comprising a first cover in which the first plate and the first cam roller assembly are positioned and a second cover in which the second plate and the second cam roller assembly are positioned, each of the first cover and the second cover including a pair of grooves that receive respective flanges of the first section and the second section.

Other features and aspects of the invention will become apparent by consideration of the following detailed description and accompanying drawings.

### BRIEF DESCRIPTION OF THE DRAWINGS

FIG. 1 is perspective view of a telescopic conveyor according to an embodiment of the invention in a retracted position.

FIG. 2 is perspective view of the telescopic conveyor according of FIG. 1 in an extended position.

FIG. 3 is a cross-sectional view of the telescopic conveyor of FIG. 1 along the line 3-3 of FIG. 1.

FIG. 4 is a detailed side view of the telescopic conveyor of FIG. 1.

FIG. 5 is a detailed side view of the telescopic conveyor of FIG. 1 with portions removed for clarity.

FIG. 6 is a detailed perspective view of one section of the telescopic conveyor of FIG. 1 with portions removed for clarity.

FIG. 7 is a detailed perspective view of the section of FIG. 6 with a rear cam roller support assembly.

FIG. 8 is a detailed perspective view of the section of FIG. 6 with the rear cam roller support assembly with a cover removed.

FIG. 9 is a detailed cross-sectional view of a portion of the rear cam roller support assembly of FIG. 6 taken along the line 9-9 of FIG. 1.

FIG. 10 is a detailed side view of the telescopic conveyor of FIG. 1 with portions removed for clarity.

FIG. 11 is a detailed perspective view of one section of the telescopic conveyor of FIG. 1 with portions removed for clarity.

FIG. 12 is a detailed perspective view of the section of FIG. 10 with a front cam roller support assembly.

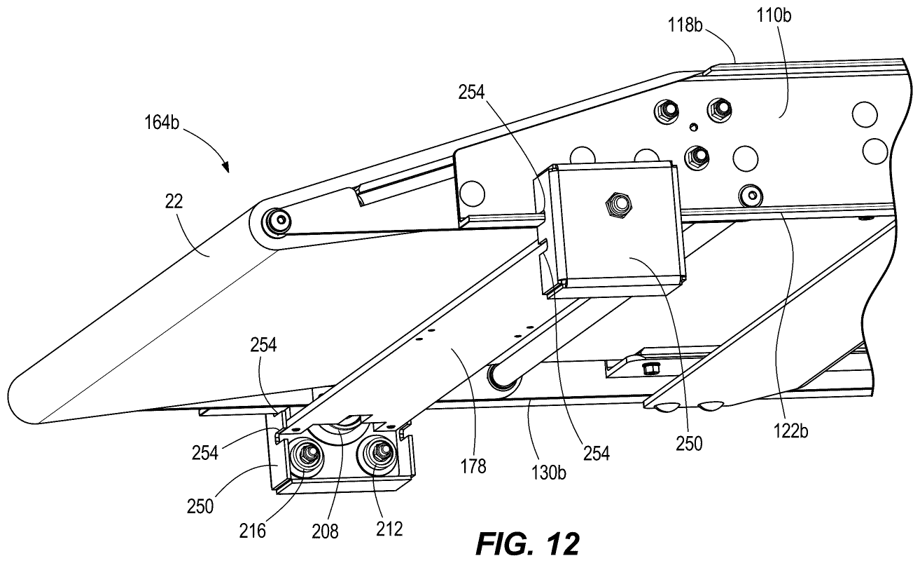

FIG. 13 is a detailed perspective view of the section of FIG. 10 with the front cam roller support assembly with a cover removed.

FIG. 14 is a detailed perspective view of a portion of the front cam roller support assembly of FIG. 10.

FIG. 15 is a detailed view of the rear cam roller support assembly of FIGS. 7-9 without the cover.

FIG. 16 is a detailed view of the front cam roller support assembly of FIGS. 11-14 without the cover.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

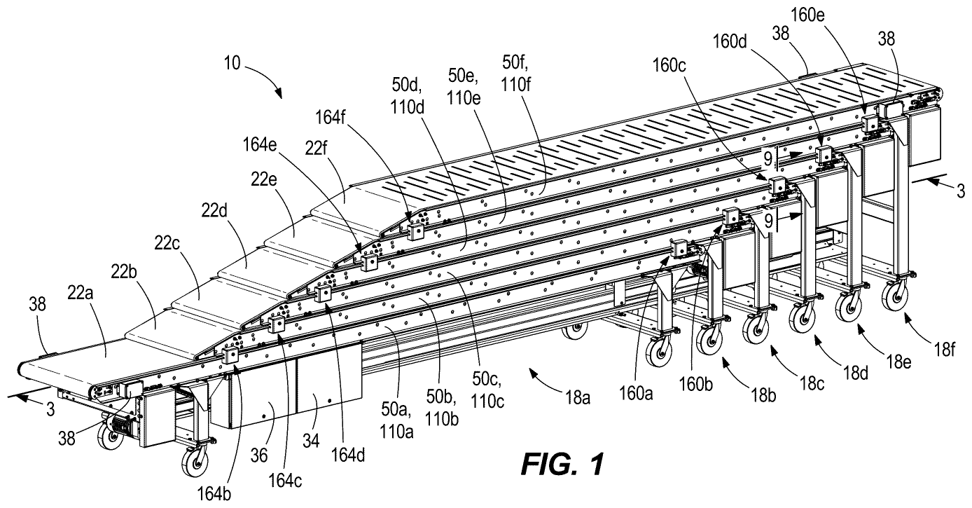

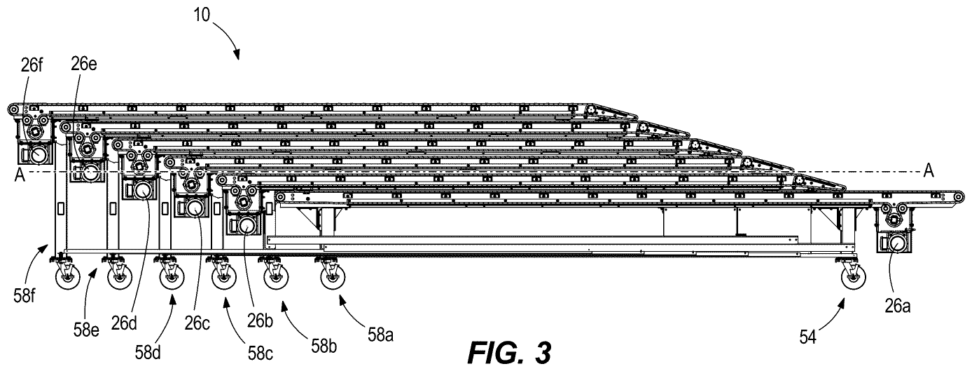

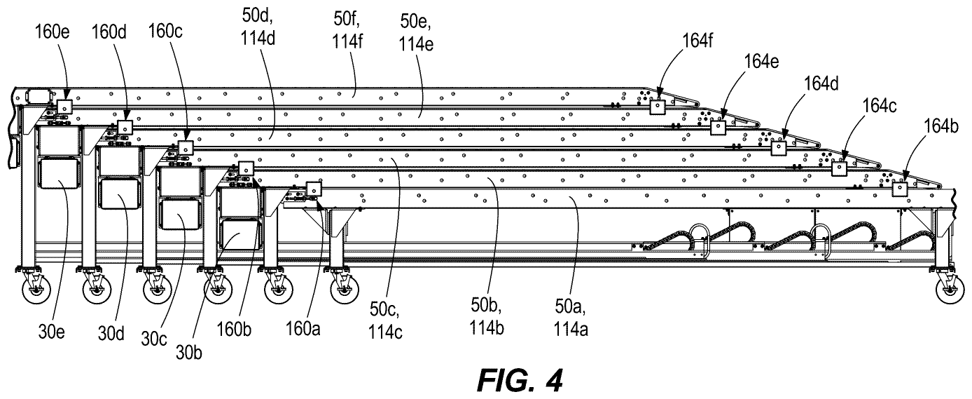

FIGS. 1-3 illustrate a telescopic conveyor 10 including base section 18a and at least one extensible section 18b, 18c, 18d, 18e, 18f. The telescopic conveyor 10 defines a longitudinal axis A. Each of the sections 18a, 18b, 18c, 18d, 18e, 18f includes a conveyor belt 22a, 22b, 22c, 22d, 22e, 22f that is typically operable at various speeds via respective motors 26a, 26b, 26c, 26d, 26e, 26f (FIG. 3) to move an item. Each of the extensible sections 18b, 18c, 18d, 18e, 18f includes an electrical panel 30b, 30c, 30d, 30e, 30f (FIG. 4), each of which includes a motor overload and contactor. The motors 26a, 26b, 26c, 26d, 26e, 26f are each in electrical communication with a conveyor signal control unit 34, which includes a signal controller, and a motor control unit 36, which includes a motor controller and a supply voltage for powering the motors 26a, 26b, 26c, 26d, 26e, 26f. The motor control unit 36 also includes the motor overload and contactor for the base section 18a. The motor 26a, 26b, 26c, 26d, 26e, 26f of each of the sections 18a, 18b, 18c, 18d, 18e, 18f is communication with the conveyor signal control unit 34 and the motor control unit 36 via one or more cables (not shown). The motors 26b, 26c, 26d, 26e, 26f of each of the extensible sections 18b, 18c, 18d, 18e, 18f communicate with the conveyor signal control unit 34 and the motor control unit 36 via one or more cables that extend from the conveyor signal control unit 34 and the motor control unit 36 to the respective electrical panel 30b, 30c, 30d, 30e, 30f. The conveyor 10 has four emergency stop actuators 38, two associated with the base section 18a and two associated with the last extensible section (in this case extensible section 18f). The emergency stop actuators 38 are also in electrical communication with the conveyor signal control unit 34 via one or more cables (not shown). A data source may be in electrical communication with the conveyor signal controller to provide data to the conveyor controller.

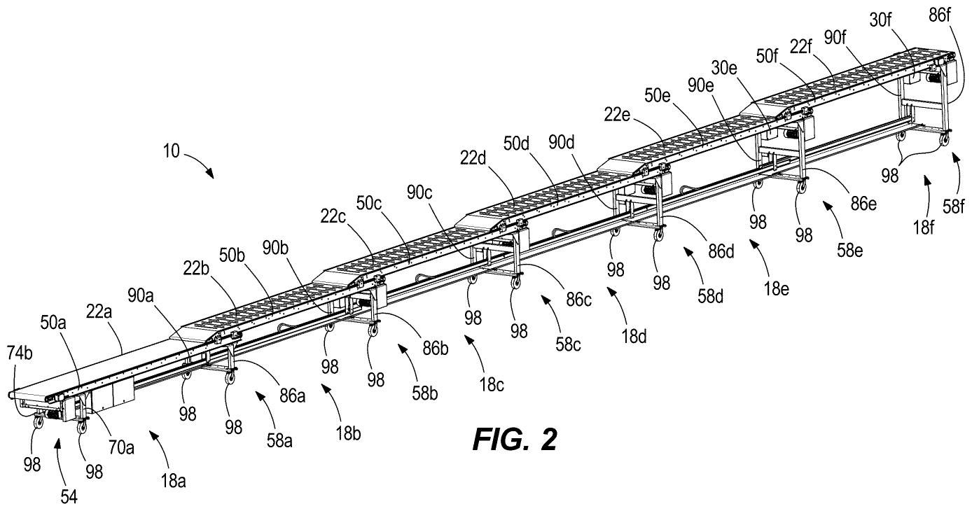

In the illustrated embodiment, there are five extensible sections 18b, 18c, 18d, 18e, 18f. Each extensible section 18b, 18c, 18d, 18e, 18f moves forward and rearward relative to the base section 18a and the adjacent extensible section(s) 18b, 18c, 18d, 18e, 18f. Each extensible section 18b, 18c, 18d, 18e, 18f moves forward and rearward along the longitudinal axis A (FIG. 3) of the telescopic conveyor 10 between a retracted position and an extended position. The telescopic conveyor 10 is movable between a retracted position (FIG. 1) in which each of the extensible sections 18b, 18c, 18d, 18e, 18f is in its retracted position and an extended position (FIG. 2) in which each of the extensible section 18b, 18c, 18d, 18e, 18f is in its extended position. The telescopic conveyor 10 is also movable from the retracted and extended positions to one or more partially extended positions in which one or more of the extensible sections 18b, 18c, 18d, 18e, 18f is in its extended position. Typically, the telescopic conveyor 10 is configured to traverse into and out of a cargo container, which may be backed into a loading/unloading dock (not shown) at a warehouse distribution center.

The base section 18a includes a base frame 50a supported by a base front support 54 and a base rear support 58a. Each of the base front support 54 and the base front support 58a includes a first leg 70a, 86a and a second leg 74a, 90a. Each of the base front support 54 and the base rear support 58a includes a pair of wheels 98. In the illustrated embodiment, each of the wheels 98 coupled to a respective leg 70a, 74a, 86a, 90a. The base conveyor belt 22a of the base section 18a is movably (e.g., rotatably) supported by the base frame 50a.

The conveyor signal control unit 34 and the motor control unit 36 of the conveyor 10 is supported by the base frame 50a. In other embodiments, the conveyor signal control unit 34 may be supported by another section (e.g., the last extensible section, which in this case is the fifth extensible section 18f) or remotely supported near the conveyor 10. Additionally, the base motor 26a is supported by the base frame 50a adjacent to the base front support 54. The base motor 26a is in electrical communication with the conveyor signal control unit 34 and the motor control unit 36 via cables (not shown).

Each of the extensible sections 18b, 18c, 18d, 18e, 18f is supported by the section immediately in front of it and an extensible rear support 58b, 58c, 58d, 58e, 58f. Each extensible section 18b includes an extensible frame 50b, 50c, 50d, 50e, 50f supported by the frame of the section immediately in front of it and an extensible rear support 58b, 58c, 58d, 58e, 58f. In the illustrated embodiment, the extensible rear support 58b, 58c, 58d, 58e, 58f of each section includes a first leg 86b, 86c, 86d, 86e, 86f and a second leg 90b, 90c, 90d, 90e, 90f. Each rear support includes a pair of wheels 98. In the illustrated embodiment, each of the wheels 98 is coupled to a respective leg. The first conveyor belt 22b, 22c, 22d, 22e, 22f of each extensible section is movably (e.g., rotatably) supported by its extensible frame.

The following discussion is in reference to the frame 50b of the first extensible section 18b, which is adjacent to the base section 18a and the second extensible section 18c. However, the structure of the frames 50a, 50c, 50d, 50e, 50f of the other sections 18a, 18c, 18d, 18e, 18f is the same as the frame 50b of unless otherwise noted.

The motor 26b and electrical panel 30b of the first extensible section 18b is supported by the extensible frame 50b adjacent to the extensible rear support 58b. The first electrical panel 30b is in electrical communication with the conveyor signal control unit 34 of the conveyor 10 and the motor control unit 36 via the cable assembly.

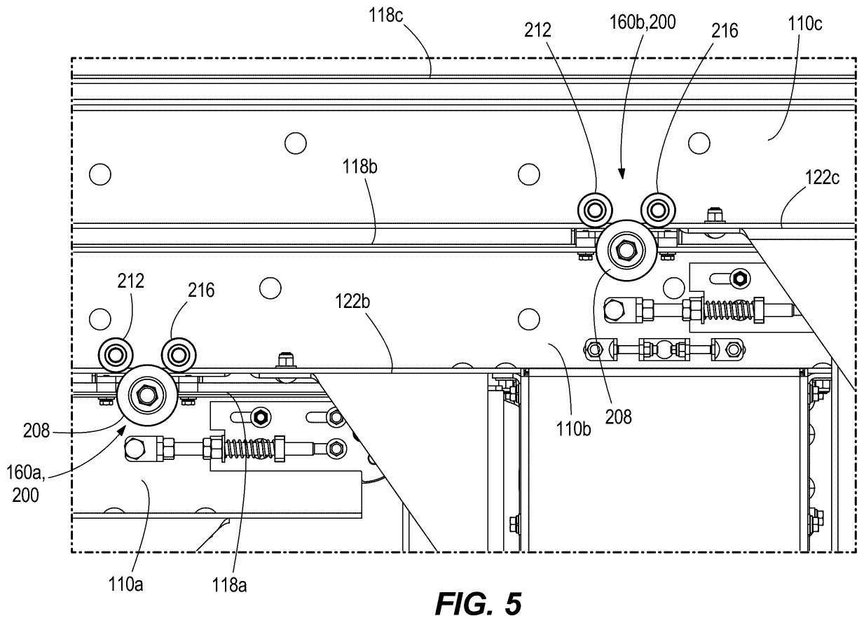

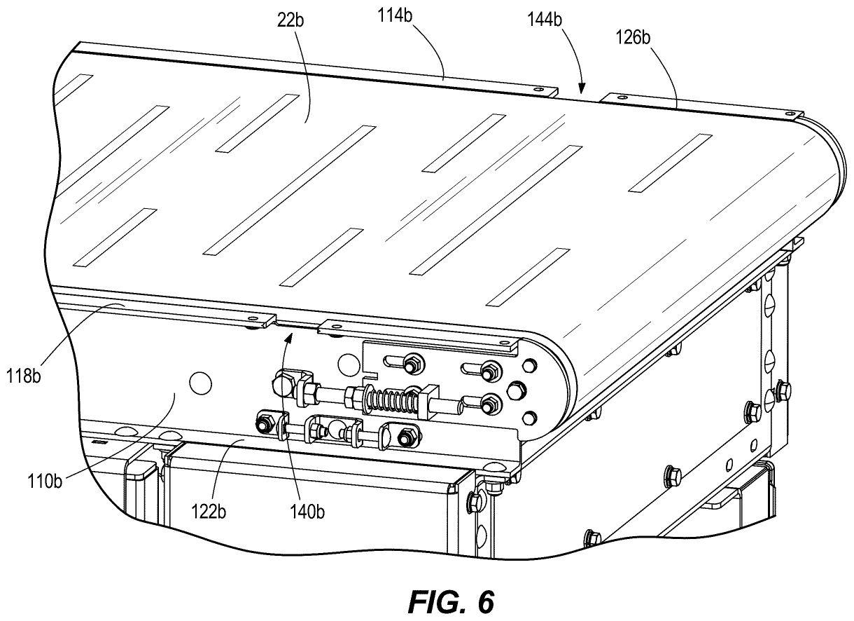

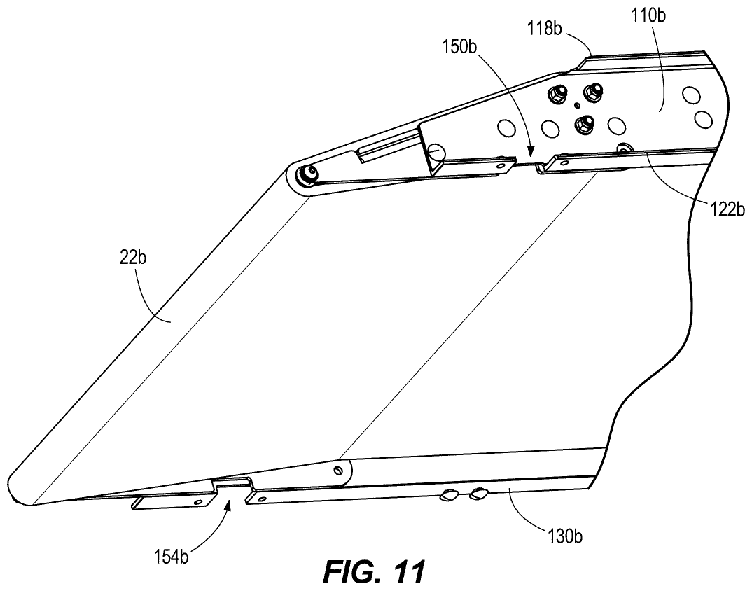

With respect to FIGS. 1 and 4, the frame 50b includes a first side frame member 110b and a second side member 114b opposite the first side frame member 110b. The frame 50b further includes a plurality of cross members (not shown) extending between the first side frame member 110a and the second side member 114b and configured to support the belt 22b. With respect to FIGS. 5 and 6, the first side frame member 110b includes an upper flange 118b and a lower flange 122b. The second side frame member 114b includes an upper flange 126b and a lower flange 130b (FIG. 11). As shown in FIG. 6, for each section, the upper flange 118b of the first side frame member 110b includes a first upper rear notch 140b and the upper flange 126b of the second side frame member 114b includes a second upper rear notch 144b. Each of the upper rear notches 140b, 144b is adjacent a rear end of the frame 50b. As shown in FIG. 11, for each section except the base section 18a, the lower flange 122b of the first side frame member 110b includes a first lower front notch 150b and the lower flange 130b of the second side frame member 114b includes a second lower front notch 154b. Each of the lower front notches 150b, 154b is adjacent to a front end of the frame 50b.

With respect to FIG. 5, each of the sections except the last (e.g., top, uppermost) extensible section (which in this case is the fifth extensible section 18f) includes a rear cam roller support assembly 160b coupled to upper flanges 118b, 126b of the frame 50b adjacent to the rear end. With respect to FIGS. 1 and 4, each of the sections except the base section 18a includes a front cam roller support assembly 164b coupled to the lower flanges 122b, 130b of the frame 50b adjacent to the front end.

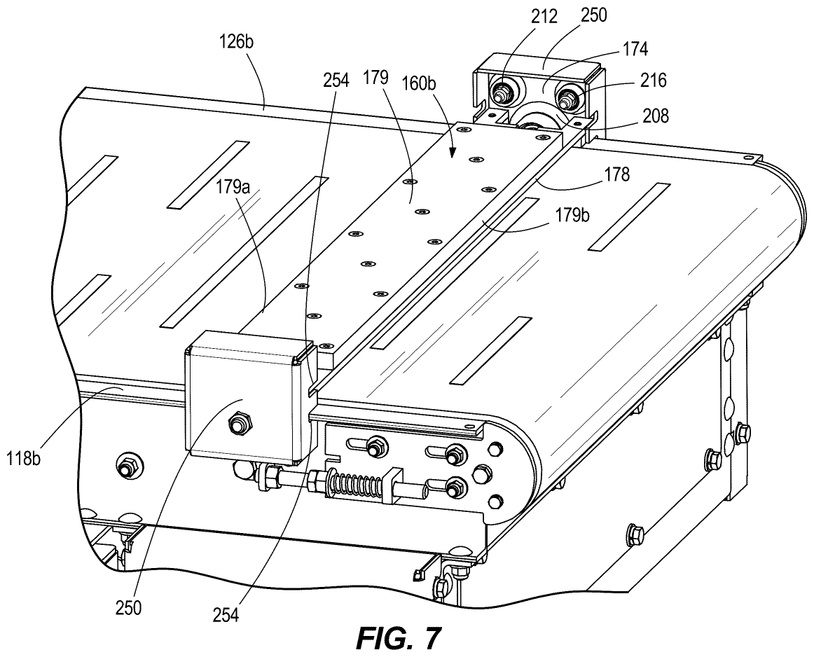

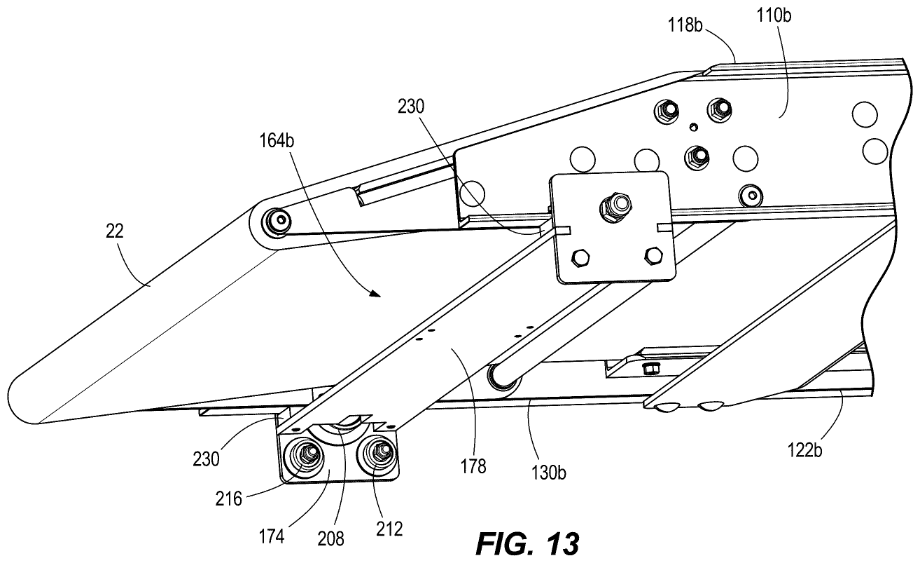

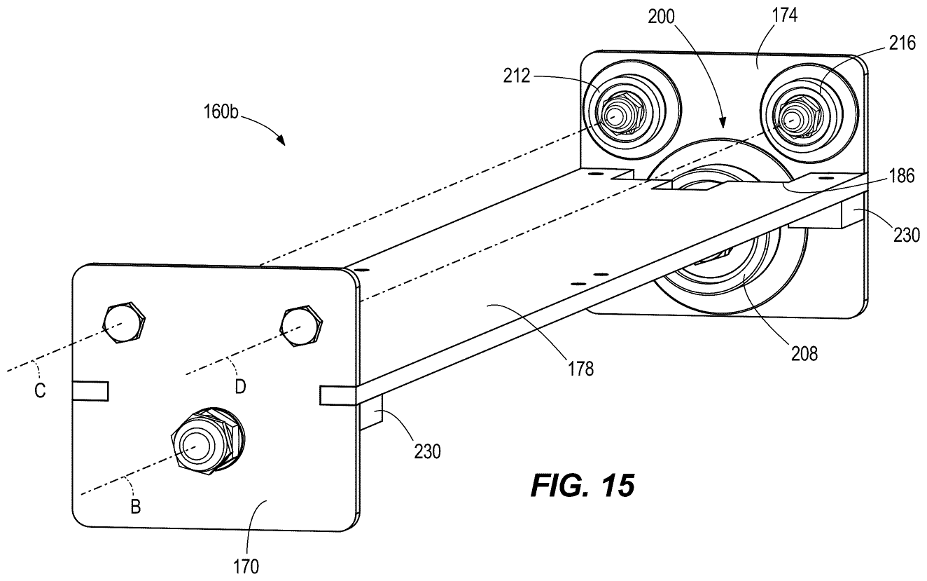

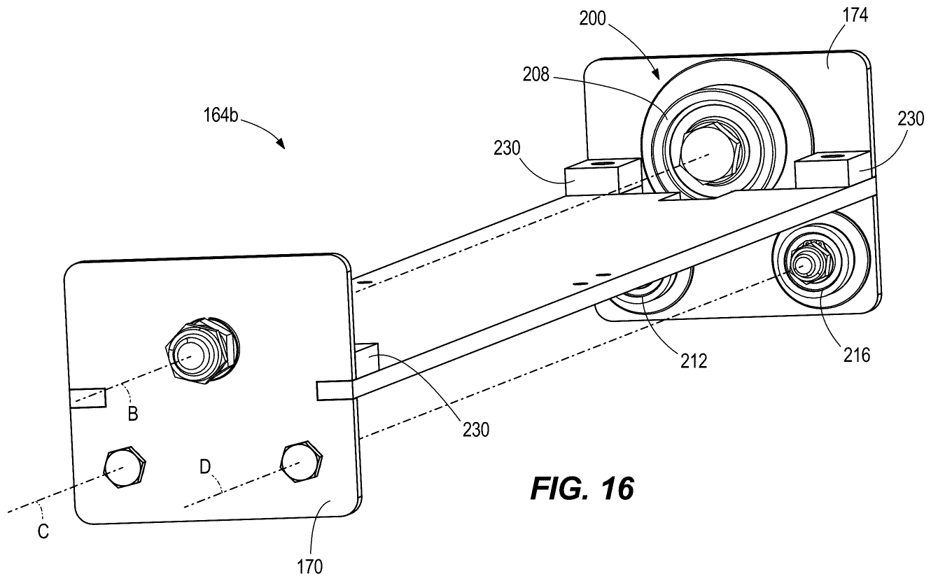

The rear cam roller support assembly 160b and the front cam roller support assembly 164b include the same components, but the orientation of the cam roller support assemblies 160b, 164b is different with respect to the extensible frame 50b, as will be discussed in greater detail below. Thus, the following discussion of one cam roller support assembly 160b applies equally to each of the cam roller support assemblies 160b, 164b of the conveyor 10. Referring to FIGS. 7-8 and 15, the cam roller support assembly 160b includes a first plate 170, a second plate 174, and a support plate 178 coupled to and extending between the first plate 170 and the second plate 174. The first end of the support plate 178 includes a first support notch 182 (FIG. 13) and the second end of the support plate 178 includes a second support notch 186 (FIGS. 7 and 15-16). The first support notch 182 faces the first plate 170 and the second support notch 186 faces the second plate 174.

The first plate 170 supports a first cam roller assembly 200 and the second plate 174 supports a second cam roller assembly 200. The first cam roller assembly 200 and the second cam roller assembly 200 are the same. The first and second cam roller assemblies 200 each includes a first cam roller 208, a second cam roller 212, and a third cam roller 216. Each of the first cam rollers 208 is rotatably coupled to the respective plate 170, 174 and rotatable about a first axis B. Each of the second cam rollers 212 is rotatably coupled to the respective plate 170, 174 and rotatable about a second axis C. Each of the third cam rollers 216 third cam roller 216 is rotatably coupled to the respective plate 170, 174 and rotatable about a third axis D. For each cam roller assembly 200, the first cam roller 208 is positioned between the second cam roller 212 and the third cam roller 216. Also, for each cam roller assembly 200, the first axis B is in a first plane while the second and third axes C, D are in a second plane that is parallel to the first plane. The first cam roller 208 is positioned adjacent to and extends partially through the respective support notch 182, 186. The second and third cam rollers 212, 216 are positioned on the same side of the support plate 178 and are spaced apart from the support plate 178. As shown, the first axis B is on an opposite side of the support plate 178 from the second and third axes C, D. Each of the first, second, and third cam rollers 208, 212, 216 are flanged cam rollers. Also, a pair of spacers 230 are coupled to a surface of the support plate 178 at the first end and the second end. The spacers 230 are an opposite side of the support plate 178 from the second and third rollers 212, 216. The spacers 230 are on opposite sides of the respective notches 182, 186.

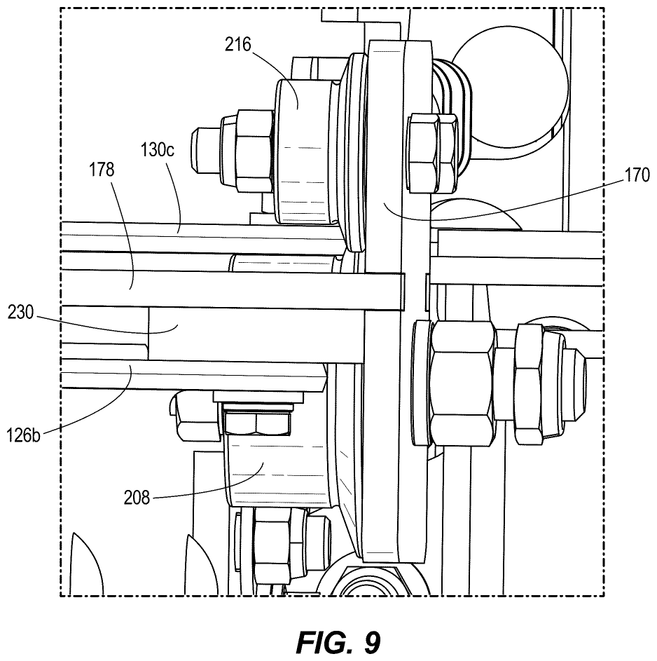

With respect to the first extensible section 18b shown in FIGS. 5 and 9, when the cam roller support assembly is used as the rear cam roller support assembly 160b, the first plate 170 is coupled to the first side frame member 110a and the second plate 174 is coupled to the second side frame member 114b such that the first support notch 182 overlaps the first upper rear notch 140b and the second support notch 186 overlaps the second upper rear notch 144b. Accordingly, the first cam rollers 208 are at least partially positioned within the respective upper rear notch 140b, 144b. Additionally, the second and third cam rollers 212, 216 are positioned above the first cam roller 208. Thus, for the rear cam roller support assembly 160b, the first cam roller 208 is a lower cam roller and the second and third rollers 212, 216 are upper cam rollers. The support plate 178 is positioned adjacent to and above the belt 22b. The spacers 230 are positioned between the respective upper flange 118b, 126b and the support plate 178. As shown, the first cam rollers 208 engage a lower surface of the respective lower flange 122c, 130c of the second extensible section 18c (e.g., the section above the first extensible section 18b) and the second and third cam rollers 212, 216 engage an upper surface of the respective lower flange 122c, 130c of the second extensible section 18c. The rear cam roller support assemblies 160a, 160c, 160d, 160e for the base section 18a, the second extensible section 18c, the third extensible section 18d, and fourth extensible section 18e operate in the same way relative to the extensible section above it.

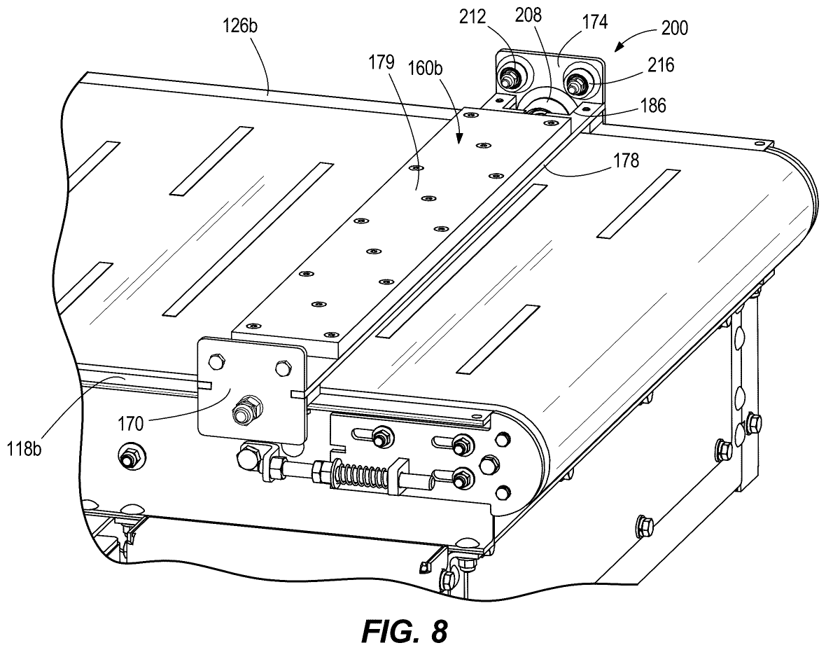

Moreover, as shown in FIGS. 7 and 8, the support plate 178 may include a stop 179, which is configured to engage the frame of the extensible section thereabove (e.g., in this case the second extensible section 18c). The stop 179 includes a first engagement surface 179a (facing the front end) that is configured to contact the frame of the extensible section thereabove at its extended position when moving from its retracted to its extended position. As the telescopic conveyor 10 is moved from the retracted position to the extended position, for each extensible section (in this case first extensible section 18b), once the extensible section above (in this case the second extensible section 18c) is in its extended position, continued movement of the extensible section 18c above exerts a force on the stop 179 at the first engagement surface 179a to pull the extensible section 18b to its extended position. Similarly, the stop 179 includes a second engagement surface 179b (facing the rear end) that is configured to engage the frame of the extensible section thereabove 18c at its retracted position when moving from the extended position to the retracted position. As the telescopic conveyor 10 is moved from the extended position to the retracted position, for each extensible section (in this case first extensible section 18b), once the extensible section above (in this case the second extensible section 18c) is in its retracted position, continued movement of the extensible section 18c above exerts a force on the stop 179 at the second engagement surface 179b to push the extensible section 18b to its retracted position. The stop 179 may have any suitable size and shape.

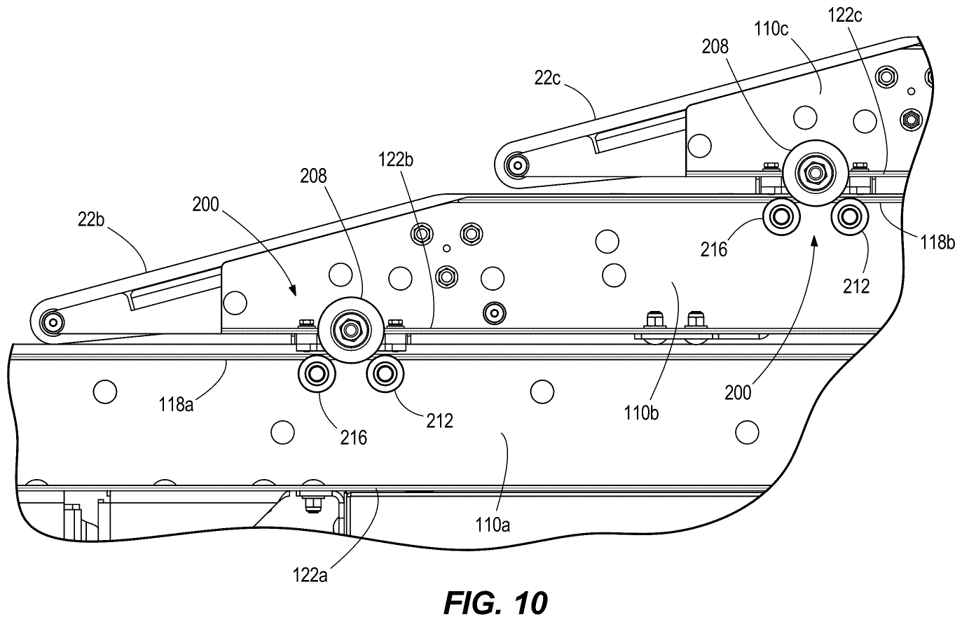

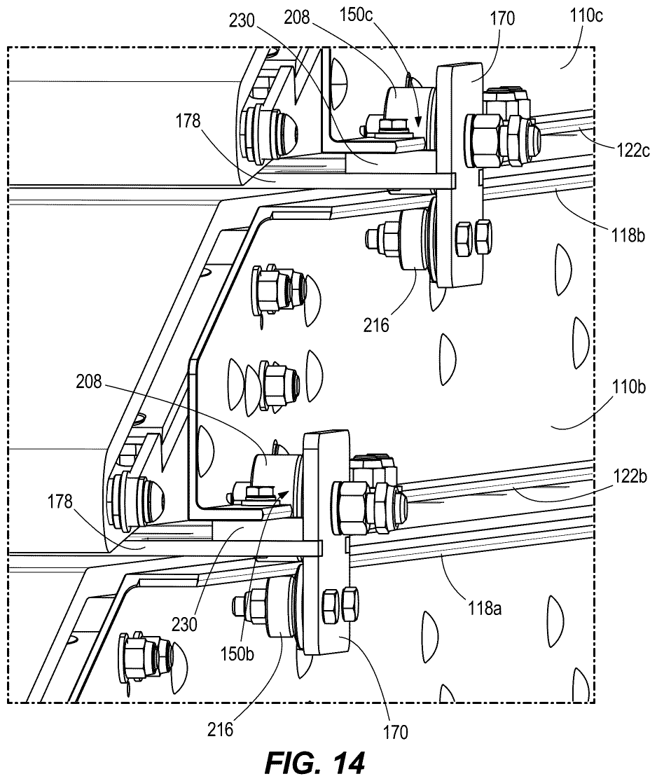

With respect to the first extensible section 18b shown in FIGS. 10, 13, and 14, when the cam roller support assembly is used as one of the front cam rollers support assemblies 164b, the first plate 170 is coupled to the first side frame member 110b and the second plate 174 is coupled to the second side frame member 114b such that the first support notch 182 overlaps the first lower front notch 150b and the second support notch 186 overlaps the second lower front notch 154b. Accordingly, the first cam rollers 208 are positioned within the respective lower front notches 150b, 154b. Additionally, the second and third cam rollers 212, 216 are positioned below the first cam roller 208. Thus, for the front cam roller support assembly 164b, the first cam roller 208 is an upper cam roller and the second and third rollers 212, 216 are lower cam rollers. Moreover, the support plate 178 is positioned adjacent to and below the belt 22b. The spacers 230 are positioned between the respective lower flange 122b, 130b and the support plate 178. As shown, the first cam rollers 208 engage an upper surface of the respective upper flange 118a, 126a of the base section 18a (e.g., the section below the first extensible section 18b) and the lower cam rollers 212, 216 engage a lower surface of the respective upper flange 118a of the base section 18a. The front cam roller support assemblies 160c, 160d, 160e, 160f for the second extensible section 18c, the third extensible section 18d, fourth extensible section 18e, and the fifth extensible section 18f operate in the same way relative to the extensible section below it.

As shown in FIG. 7, the cam roller assemblies are protected by covers 250 that enclose the respective plate 170, 174 and cam roller assemblies 200. As shown, each of the covers 250 includes a pair of grooves 254 that receive the respective flange of the side frame members 110b, 110c.

Collectively, the cam roller assemblies 200 of the rear cam roller support assembly 160b and the front cam roller support assembly 164b maintain the alignment of each extensible section 18b, 18c, 18d, 18e, 18f along the longitudinal axis A as each section moves between the retracted and extended positions. Moreover, the cam roller assemblies 200 of the rear cam roller support assembly 160b and the front cam roller support assembly 164b prevent lateral movement of the respective sections 18b, 18c, 18d, 18e, 18f, such that it is easier to move the conveyor 10 and extend and retract the respective sections. That is, as each extensible section 18b, 18c, 18d, 18e, 18f moves from the retracted position to the extended position, on outer surfaces of both sides of the frame 50b, 50c, 50d, 50e, 50f the cam roller assemblies 200 laterally constrain the movement of the respective frame 50b, 50c, 50d, 50e, 50f relative to the sections above and/or below the same. Moreover, with respect to the first extensible section 18b, the rollers 208, 212, 216 of the rear cam roller support assemblies 160a of the base section 18a (e.g., the section below the first extensible section 18b) apply pressure to and roll along opposite surfaces of the lower flanges 122b, 130b of the both side frame members 110a, 114b as the first extensible section 18b is moved between the retracted and the extended position. Similarly, with further respect to the first extensible section 18b (but as equally applicable to the other extensible sections), the rollers 208, 212, 216 of the front cam roller support assemblies 164b of the first extensible section 18b apply pressure to and roll along opposite surfaces of the upper flanges 118a, 126a of the side frame members 110a, 114a of the base section 18a (e.g., the section below the first extensible section) as the first extensible section 18b is moved between the retracted and the extended position. Accordingly, lateral movement of the first extensible section 18b relative to the base section 18a is prevented by cam roller assemblies at both the front and rear thereof as the first extensible section 18b moves. This is, at least in part, because there are cam roller assemblies 200 on outer surfaces of both sides of the frame 50b in both the front and rear, such that lateral movement relative to the base section 18a is prevented.

Various features of the invention are set forth in the following claims.

What is claims is:

1. A telescopic conveyor comprising:
a base section including
a base frame including a first side frame member and a second side frame member opposite the first side frame member, each of the first side frame member and the second side frame member supporting a base conveyor belt and including
an upper flange;
a lower flange; and
a first cam roller support assembly coupled to the base frame and including a first cam roller assembly and a second cam roller assembly; and
an extensible section supported by and movable relative to the base section, the extensible section configured to move relative to the base section between a retracted position and an extended position, the extensible section including
an extensible frame including a first side frame member and a second side frame member opposite the first side frame member, each of the first side frame member and the second side frame member supporting an extensible conveyor belt and including
an upper flange; and
a lower flange;
wherein as the extensible section moves between the retracted position and the extended position, the first cam roller assembly of the first cam roller support assembly engages the lower flange of the first side frame member of the extensible section and the second cam roller assembly of the first cam roller support assembly engages the lower flange of the second side frame member of the extensible section.

2. The telescopic conveyor of claim 1, wherein the extensible frame further comprises a second cam roller support assembly coupled to the extensible frame and configured to engage the base frame, the second cam roller support assembly including a first cam roller assembly and a second cam roller assembly.

3. The telescopic conveyor of claim 2, wherein as the extensible section moves between the retracted position and the extended position, the first cam roller assembly of the second cam roller support assembly engages the upper flange of the first side frame member of the base frame and the second cam roller assembly of the second cam roller support assembly engages the upper flange of the second side frame member of the base frame.

4. The telescopic conveyor of claim 3, wherein the first cam roller support assembly is positioned adjacent a rear of the base frame and the second cam roller support assembly is positioned adjacent a front of the extensible frame.

5. The telescopic conveyor of claim 1, wherein the first cam roller assembly includes a first cam roller that engages a lower surface of the lower flange of the first side frame member of the extensible frame and a second cam roller that engages an upper surface of the lower flange of the first side frame member of the extensible frame, and wherein the second cam roller assembly includes a first cam roller that engages a lower surface of the lower flange of the second side frame member the extensible frame and a second cam roller that engages an upper surface of the lower flange of the second side frame member the extensible frame.

6. The telescopic conveyor of claim 5, wherein the first cam roller support assembly includes a support plate extending between the first cam roller assembly and the second cam roller assembly and above the upper flange of each of the first side frame member and the second side frame member of the base frame.

7. The telescopic conveyor of claim 6, wherein the first cam roller of the first cam roller assembly and the first cam roller of the second cam roller assembly are rotatable about a first axis and the second cam roller of the first cam roller assembly and the second cam roller of the second cam roller assembly are rotatable about a second axis that is parallel to the first axis, the first axis and the second axis being positioned on opposite sides of the support plate.

8. A telescopic conveyor comprising:
a plurality of sections including
a base section; and
a plurality of extensible sections supported by and movable relative to the base section;
wherein each of the plurality of sections includes a frame supporting a conveyor belt and including a first side frame member and a second side frame member opposite the first side frame member, each of the first side frame member and the second side frame member including an upper flange and a lower flange; and
a plurality of roller support assemblies, each roller support assembly of the plurality of roller support assemblies being supported by the frame of one of the plurality of sections and positioned between the one of the plurality of sections and an adjacent section of the plurality of sections, each of the plurality of roller support assemblies including a first cam roller support assembly coupled to the frame of the one of the plurality of sections and including a first cam roller assembly and a second cam roller assembly;
wherein the first cam roller assembly of the first cam roller support assembly engages one of the upper flange and the lower flange of the first side frame member of the adjacent section of the plurality of sections and the second cam roller assembly of the first cam roller support assembly engages one of the upper flange and the lower flange of the second side frame member of the adjacent section of the plurality of sections.

9. The telescopic conveyor of claim 8, wherein a subset of the plurality of roller support assemblies are rear roller support assemblies, and wherein the base section includes, at a rear end thereof, one of the rear roller support assemblies end each of the plurality of extensible sections except a rear-most extensible section of the plurality of extensible sections includes, at a rear end, one of the rear roller support assemblies.

10. The telescopic conveyor of claim 9, wherein for each of the rear roller support assemblies, the first cam roller assembly engages the lower flange of the first side frame member of the adjacent section of the plurality of sections and the second cam roller assembly engages the lower flange of the second side frame member of the adjacent section of the plurality of sections.

11. The telescopic conveyor of claim 8, wherein a subset of the plurality of roller support assemblies are front roller support assemblies, each of the plurality of extensible sections includes, at a front end, one of the front roller support assemblies.

12. The telescopic conveyor of claim 11, wherein for each of the front roller support assemblies, the first cam roller assembly engages the upper flange of the first side frame member of the adjacent section of the plurality of sections and the second cam roller assembly engages the upper flange of the second side frame member of the adjacent section of the plurality of sections.

13. The telescopic conveyor of claim 8, wherein for each of the plurality of roller support assemblies, the first cam roller assembly includes a first cam roller that engages an upper surface of the one of the upper flange and the lower flange of the first side frame member and a second cam roller that engages a lower surface of the one of the upper flange and the lower flange of the first side frame member, and wherein the second cam roller assembly includes a first cam roller that engages an upper surface of the one of the upper flange and the lower flange of the second side frame member and a second cam roller that engages a lower surface of the one of the upper flange and the lower flange of the second side frame member.

14. The telescopic conveyor of claim 13, wherein the first cam roller support assembly includes a support plate extending between the first cam roller assembly and the second cam roller assembly.

15. The telescopic conveyor of claim 14, wherein the first cam roller of the first cam roller assembly and the first cam roller of the second cam roller assembly are rotatable about a first axis and the second cam roller of the first cam roller assembly and the second cam roller of the second cam roller assembly are rotatable about a second axis that is parallel to the first axis, the first axis and the second axis being positioned on opposite sides of the support plate.

16. A telescopic conveyor comprising:
a base section including
a base frame including a first side frame member and a second side frame member opposite the first side frame member, each of the first side frame member and the second side frame member supporting a base conveyor belt and including
an upper flange;
a lower flange; and
an extensible section supported by and movable relative to the base section, the extensible section configured to move relative to the base section between a retracted position and an extended position, the extensible section including
an extensible frame including a first side frame member and a second side frame member opposite the first side frame member, each of the first side frame member and the second side frame member supporting an extensible conveyor belt and including
an upper flange;
a lower flange; and
a first cam roller support assembly coupled to the extensible frame and including a first cam roller assembly and a second cam roller assembly;
wherein as the extensible section moves between the retracted position and the extended position, the first cam roller assembly of the first cam roller support assembly engages the upper flange of the first side frame member of the base section and the second cam roller assembly of the first cam roller support assembly engages the upper flange of the second side frame member of the base section.

17. The telescopic conveyor of claim 16, wherein the extensible section is a first extensible section, the extensible frame is a first extensible frame, and the extensible conveyor belt is a first extensible conveyor belt, and further comprising
a second extensible section supported by and movable relative to the first extensible section, the second extensible section configured to move relative to the first extensible section between a retracted position and an extended position, the second extensible section including
a second extensible frame including a first side frame member and a second side frame member opposite the first side frame member, each of the first side frame member and the second side frame member supporting a second extensible conveyor belt and including
an upper flange; and
a lower flange.

18. The telescopic conveyor of claim 17, wherein the first cam roller support assembly is positioned adjacent a front of the first extensible frame and wherein the first extensible frame further comprises a second cam roller support assembly positioned adjacent to a rear of the first extensible frame, the second cam roller support assembly configured to engage the second extensible frame and including a first cam roller assembly and a second cam roller assembly.

19. The telescopic conveyor of claim 18, wherein as the second extensible section moves between the retracted position and the extended position, the first cam roller assembly of the second cam roller support assembly engages the lower flange of the first side frame member of the second extensible frame and the second cam roller assembly of the second cam roller support assembly engages the lower flange of the second side frame member of the second extensible frame.

20. The telescopic conveyor of claim 16, wherein
the first cam roller assembly includes a first cam roller that is rotatable about a first axis and engages an upper surface of the upper flange of the first side frame member of the base frame and a second cam roller that is rotatable about a second axis and engages a lower surface of the upper flange of the first side frame member of the base frame, the second axis being parallel to the first axis,
the second cam roller assembly includes a first cam roller that is rotatable about the first axis and engages an upper surface of the upper flange of the second side frame member of the base frame and a second cam roller that is rotatable about the second axis and engages a lower surface of the upper flange of the second side frame member of the base frame, and
the first cam roller support assembly further includes a support plate extending between the first cam roller assembly and the second cam roller assembly, the support plate positioned below the lower flange of each of the first side frame member and the second side frame member of the extensible frame, the first axis and the second axis being positioned on opposite sides of the support plate.
